(19) United States
(12) Patent Application Publication
(10) Pub. No.: US 2024/0149194 A1
(43) Pub. Date: May 9, 2024

(54) Filter System with a Filter Element and a Safety Assembly, a Safety Assembly, and a Filter Element

(71) Applicant: MANN+HUMMEL GmbH, Ludwigsburg (DE)

(72) Inventor: Jan SVOBODA, Cíhalín (CZ)

(21) Appl. No.: 18/510,767

(22) Filed: Nov. 16, 2023

Related U.S. Application Data
(63) Continuation of application No. PCT/EP2022/063644, filed on May 19, 2022.

(30) Foreign Application Priority Data
May 21, 2021 (EP) 21175337.1

(51) Int. Cl. B01D 35/147

(52) U.S. Cl. CPC B01D 35/147; B01D 2201/4007; B01D 2201/4046

(57) ABSTRACT

The invention relates to a filter system comprising a housing and a filter element being accommodated in the housing, wherein a safety assembly is arranged inside the housing, having a blocking mode and an unblocking mode depending on an axial and/or rotational position of the filter element in the housing and being configured to provide access of a sealing structure of the filter element to a sealing area of the safety assembly in the unblocking mode and to block access of the sealing structure to the sealing area in the blocking mode when the sealing structure of the filter element is moved towards the sealing area. The invention further relates to a safety assembly for a filter system and a filter element.

### TECHNICAL FIELD

The invention relates to a filter system with a filter element and a safety assembly, and a safety assembly and a filter element for such a filter system.

### PRIOR ART

Such filter systems or filter elements are used for filtering gaseous or liquid fluids. In motor vehicles and industrial engines such filter systems are used for filtering especially fuel, especially diesel fuel or gasoline, motor oil or hydraulic oil.

US 20150033689 A1 discloses a filter system for filtering fluids which has a housing, an inlet, and an outlet. A filter element is arranged inside the housing. A cover closes the housing and provides access to the filter element inside the housing. A securing device prevents the housing from being closed by the cover when the filter element is missing. The filter element has at least one filter element guide path section. The housing or the cover has a rim area with at least one rim guide path section. The filter element guide path section and the rim guide path section supplement one another to a guide path. The securing device comprises at least one securing element arranged on the cover or the housing. The securing element is guided on the guide path when a closing movement is carried out for closing the housing by the cover.

### DISCLOSURE OF THE INVENTION

It is an object of the invention to provide a filter system with a filter element and a safety assembly which allows for a reliable and correct mounting of the filter element.

Another object of the invention is to provide a safety assembly for such a filter system.

Another object of the invention is to provide a filter element for such a filter system.

The first object is achieved by a filter system comprising a housing with a housing head and a housing cover, a fluid inlet and a fluid outlet and a filter element being accommodated in the housing, the filter element comprising a center pipe having a longitudinal direction and being surrounded by a filter bellows, the filter bellows comprising an end cap at one or both of its end regions, the filter element further comprising a sealing structure, particularly a gasket, at the end cap, wherein a safety assembly is arranged inside the housing, having a blocking mode and an unblocking mode depending on an axial and/or rotational position of the filter element in the housing and being configured to provide access of the sealing structure of the filter element to a sealing area of the safety assembly in the unblocking mode and to block access of the sealing structure of the filter element to the sealing area of the safety assembly in the blocking mode when the sealing structure of the filter element is moved towards the sealing area, the safety assembly having a first section arranged at the housing and a second section arranged at the filter element, the first and second sections comprising at least one blocking element and at least one unblocking element configured to cooperate with the at least one blocking element, the at least one blocking element comprising an activation surface and the at least one unblocking element comprising a cam for pushing the activation surface in a radial direction when a contact between the cam and the activation surface is established.

Another object is achieved by a safety assembly for a filter system, the filter system comprising a filter element and a housing, having a sealing area and having a blocking mode and an unblocking mode depending on an axial and/or rotational position of the filter element in the housing and being configured to provide access of a sealing structure of the filter element to a sealing area of the safety assembly in the unblocking mode and to block access of the sealing structure of the filter element to the sealing area in the blocking mode when the sealing structure of the filter element is moved towards the sealing area, having a first section arranged at the housing and a second section arranged at the filter element, the first and second sections comprising at least one blocking element and at least one unblocking element configured to cooperate with the at least one blocking element, the at least one blocking element comprising an activation surface and the at least one unblocking element comprising a cam for pushing the activation surface in a radial direction when a contact between the cam and the activation surface is established.

Another object is achieved by a filter element for a filter system, comprising a center pipe having a longitudinal direction and being surrounded by a filter bellows, the filter bellows comprising an end cap at one or both of its end regions, and comprising a section of a safety assembly with either at least one unblocking element or at least one blocking element configured to cooperate with either the at least one blocking element or the at least one unblocking element of a first section of the safety assembly, the filter element further comprising a sealing structure, particularly a gasket, on one of its end regions, wherein the at least one blocking element and the at least one unblocking element are configured to provide access of the sealing structure to a sealing area of the safety assembly in the unblocking mode and to block access of the sealing structure to the sealing area in the blocking mode when the sealing structure of the filter element is moved towards the sealing area.

Favorable embodiments and advantages of the invention are apparent from the further claims, the description and the drawings.

In a first aspect of the invention a filter system is proposed, comprising a housing with a housing head and a housing cover, a fluid inlet and a fluid outlet and a filter element being accommodated in the housing, the filter element comprising a center pipe having a longitudinal direction and being surrounded by a filter bellows, the filter bellows comprising an end cap at one or both of its end regions, the filter element further comprising a sealing structure, particularly a gasket, at the end cap. A safety assembly is arranged inside the housing, having a blocking mode and an unblocking mode depending on an axial and/or rotational position of the filter element in the housing and being configured to provide access of the sealing structure of the filter element to a sealing area of the safety assembly in the unblocking mode and to block access of the sealing structure of the filter element to the sealing area of the safety assembly in the blocking mode when the sealing structure of the filter element is moved towards the sealing area. The safety assembly has a first section arranged at the housing and a second section arranged at the filter element, the first and second sections comprising at least one blocking element and at least one unblocking element configured to cooperate with the at least one blocking element. The at least one blocking element comprises an activation surface and the at least one unblocking element comprises a cam for pushing the activation surface in a radial direction when a contact between the cam and the activation surface is established.

The inventive filter system comprises a safety assembly for ensuring a correct and reliable mounting of the filter element to the housing of the filter system. The safety assembly comprises two sections where the first section is arranged at the housing and the second section is arranged at the filter element, preferably at the center pipe of the filter element. The first section is arranged at the housing cover of the filter system. Both sections are cooperating when mounting the filter element to the housing.

The safety assembly is arranged inside the housing and has a blocking mode and an unblocking mode. The safety assembly may be switched from the blocking mode to the unblocking mode and vice versa depending on an axial and/or rotational position of the filter element in the housing. The safety assembly provides access of the sealing structure of the filter element to the sealing area of the safety assembly in the unblocking mode and blocks access of the sealing structure of the filter element to the sealing area in the blocking mode.

Before mounting of the filter element to the housing the safety assembly is in the blocking mode where access of a sealing structure of the filter element to a sealing area of the safety assembly is blocked by a blocking element. Connection of the sealing structure and the sealing area is needed for a proper sealing of a raw fluid region in the filter system against a filtered fluid region.

The sealing may favorably comprise a sealing surface of the sealing area circumferencing the blocking element arranged inside the housing for sealing a raw fluid region of the filter system against a filtered fluid region by interacting with the sealing structure of the filter element.

The access may be unblocked when a filter element with a corresponding unblocking element is mounted to the blocking element of the safety assembly. The blocking element may be realized by a construction cage with at least one spring member, whereas the unblocking element may be realized by a cam arranged at the center pipe of the filter element, the cam cooperating with the spring member in an appropriate manner to unblock the sealing area. For this purpose, the cam may be arranged at the center pipe pointing radially inwards.

In a favorable embodiment the blocking element may be arranged at the first section in the safety assembly arranged in the housing of the filter system, whereas the unblocking element may be arranged at the second section of the safety assembly in the filter element. Yet, in another embodiment the blocking element may also be arranged at the second section in the filter element and the unblocking element may be arranged at the first section in the housing.

Favorably the safety assembly may also comprise facilities to fix the filter element to the safety assembly and thus to fix the filter element to the housing cover. This may be achieved by locking the center pipe of the filter element to the blocking element of the safety assembly. Due to another embodiment an end cap of the filter element may be locked by the blocking element thus fixing the filter element to the housing of the filter system.

A further advantage of the inventive filter system is that no positioning of the filter element is needed due to some self-positioning structure and guiding grooves of the blocking element of the safety assembly. These structures lead the filter element during mounting in a longitudinal direction by a guiding rotation into the correct position in the housing. Further the filter element is led to an end position where it is fixed by the safety assembly in a locked position.

The fluid inlet as well as the fluid outlet may be favorably arranged in the housing head.

The safety assembly may favorably comprise a cage as a blocking element and at least one spring member. The safety assembly in mounted inside the housing cover of the housing of the filter system. The spring member has a blocking lip. The lip blocks access of the sealing structure of the filter element to the sealing area of the housing cover. To get access to the sealing area the spring member is bent by an unblocking element of the filter element with a special geometry, e.g., a cam radially oriented. A special labyrinth realized as a groove in the cage is used for guiding the unblocking element to unblock the access to the sealing area and also for pulling the filter element out of the housing cover. The system is preventing the use of a filter element without such an unblocking element, because the sealing area is blocked by the spring element.

Advantageously only a filter element with the appropriate geometry of the unblocking element may be assembled in the housing. Further the filter element may be pulled out of the housing during cover dismantling when the unblocking element is in an end position of the guiding groove thus locking the filter element inside the housing cover. The labyrinth in the blocking element favorably enables positioning of the sealing structure of the filter element to the sealing area of the safety assembly.

According to a favorable embodiment of the filter system, the blocking element may comprise at least one spring member comprising the activation surface and a radially protruding lip, wherein the lip is retractable from its blocking position by pushing the activation surface in a radial direction. The spring member may favorably realize the blocked mode where the lip is in protruded position and blocks an access to the sealing area of the housing cover. By pushing the activation surface in a radially inward direction the lip may be pushed back too, thus switching to the unblocked mode where access of the sealing structure of the filter element to the sealing area may be granted.

The blocking element may favorably be connected to the housing cover of the filter system.

According to a favorable embodiment of the filter system, the blocking element may comprise a guiding groove which leads the unblocking element to the activation surface by a rotational movement when moving the filter element in the longitudinal direction towards the blocking element. A further advantage of the inventive filter system is that no positioning of the filter element is needed due to some guiding grooves of the blocking element of the safety assembly. These structures lead the filter element during mounting in a longitudinal direction by a guiding rotation into the correct position in the housing.

According to a favorable embodiment of the filter system, the blocking element may comprise a locking structure wherein the filter element is locked to the blocking element when the cam is inserted into the locking structure by a rotational movement of the filter element after surpassing the activation surface by the cam in the longitudinal direction. Favorably the safety assembly may also comprise facilities to fix the filter element to the safety assembly and thus to fix the filter element to the housing cover. This may be achieved by locking the center pipe of the filter element to the blocking element of the safety assembly. Thus, the filter element is led to an end position where it is fixed by the safety assembly in a locked position.

According to a favorable embodiment of the filter system, the locking structure may comprise two neighbored ribs arranged on a circumference of the blocking element. The cam may be locked between the two ribs in an axial direction of the filter element. Thus, a movement of the filter element along the longitudinal direction may favorably be inhibited.

According to a favorable embodiment of the filter system, the filter element may be locked to the blocking element by the lip of the spring member when the cam is moved to an end position by a rotational movement of the filter element after surpassing the activation surface by the cam in the longitudinal direction. Due to this further embodiment the end cap of the filter element may be locked by the blocking element thus fixing the filter element to the housing of the filter system. Thus, a movement of the filter element along the longitudinal direction may also be inhibited.

According to a favorable embodiment of the filter system, a single spring member may be arranged in the blocking element parallel to the longitudinal direction, which is formed U-shaped comprising two spring member branches parallel to the longitudinal direction, wherein the spring member branches may be connected by a bridge member. Advantageously the single spring member may easily be mounted and fixed in the blocking element. Reduced manufacturing costs and handling costs may favorably result.

According to a favorable embodiment of the filter system, the filter element may comprise at least one coding element configured to cooperate with a coding counter element arranged in the safety assembly, when the filter element is mounted to the housing. Thus, a fixed assignment of a filter element to a defined filter system is possible. The filter system is preventing the use of a filter element without such a coding element or the wrong coding element, because access to the sealing area of the safety assembly may be blocked by the blocking element.

According to a favorable embodiment of the filter system, the coding element may be formed as a protruding pin arranged at the center pipe of the filter element pointing radially inward, whereas the coding counter element is formed as a groove in the blocking element parallel to the longitudinal direction. In particular, the blocking element may comprise a positioning structure connected to the groove which leads the pin to the groove by a rotational movement when moving the filter element in the longitudinal direction towards the blocking element. Advantageously the filter element may be mounted to the housing cover by inserting the pin into the appropriate groove of the blocking element simultaneously with inserting the cam as unblocking element into the guiding groove. Thus, the use of a filter element without such a coding element or the wrong coding element may be prevented, because access to the sealing area of the safety assembly may be blocked by the blocking element.

According to another aspect of the invention a safety assembly for a filter system is proposed, the filter system comprising a filter element and a housing. The safety assembly has a sealing area and has a blocking mode and an unblocking mode depending on an axial and/or rotational position of the filter element in the housing and is configured to provide access of a sealing structure of the filter element to a sealing area of the safety assembly in the unblocking mode and to block access of the sealing structure of the filter element to the sealing area in the blocking mode when the sealing structure of the filter element is moved towards the sealing area. The safety assembly has a first section arranged at the housing and a second section arranged at the filter element, the first and second sections comprising at least one blocking element and at least one unblocking element configured to cooperate with the at least one blocking element. The at least one blocking element comprises an activation surface and the at least one unblocking element comprises a cam for pushing the activation surface in a radial direction when a contact between the cam and the activation surface is established.

The safety assembly may favorably ensure a correct and reliable mounting of the filter element to the housing of the filter system. The safety assembly comprises two sections where the first section is arranged at the housing and the second section is arranged at the filter element, preferably at the center pipe of the filter element. The first section is arranged at the housing cover of the filter system. Both sections are cooperating when mounting the filter element to the housing.

Before mounting of the filter element to the housing the safety assembly is in a blocking mode where access of a sealing structure of the filter element to a sealing area of the safety assembly is blocked by a blocking element. Connection of the sealing structure and the sealing area is needed for a proper sealing of a raw fluid region in the filter system against a filtered fluid region.

The access may be unblocked when a filter element with a corresponding unblocking element is mounted to the blocking element. The blocking element may be realized by a construction cage with at least one spring member, whereas the unblocking element may be realized by a cam arranged at the center pipe, the cam cooperating with the spring member in an appropriate manner to unblock the sealing area. For this purpose, the cam may be arranged at the center pipe pointing radially inwards.

According to another aspect of the invention a filter element for a filter system is proposed, comprising a center pipe having a longitudinal direction and being surrounded by a filter bellows, the filter bellows comprising an end cap at one or both of its end regions, and comprising a section of a safety assembly with either at least one unblocking element or at least one blocking element configured to cooperate with either the at least one blocking element or the at least one unblocking element of a first section of the safety assembly. The filter element further comprises a sealing structure, particularly a gasket, on one of its end regions. The at least one blocking element and the at least one unblocking element are configured to provide access of the sealing structure to a sealing area of the safety assembly in the unblocking mode and to block access of the sealing structure to the sealing area in the blocking mode when the sealing structure of the filter element is moved towards the sealing area.

Before mounting of the filter element to the housing of the filter system the safety assembly may be in a blocking mode where access of a sealing structure of the filter element to a sealing area of the safety assembly is blocked by a blocking element. Connection of the sealing structure and the sealing area is needed for a proper sealing of a raw fluid region in the filter system against a filtered fluid region.

The access may be unblocked when the filter element with a corresponding unblocking element is mounted to the blocking element. The blocking element may be realized by a construction cage with at least one spring member, whereas the unblocking element may be realized by a cam arranged at the center pipe, the cam cooperating with the spring member in an appropriate manner to unblock the sealing area. For this purpose, the cam may be arranged at the center pipe pointing radially inwards.

Favorably the filter element may also be fixed to the safety assembly and thus to the housing cover of the filter system. This may be achieved by locking the center pipe of the filter element to the blocking element of the safety assembly.

The safety assembly is arranged inside the housing of the filter system and has a blocking mode and an unblocking mode. The safety assembly may be switched from the blocking mode to the unblocking mode and vice versa depending on an axial and/or rotational position of the filter element in the housing. The safety assembly provides access of the sealing structure of the filter element to the sealing area of the safety assembly in the unblocking mode and blocks access of the sealing structure of the filter element to the sealing area in the blocking mode.

According to a favorable embodiment of the filter element, the at least one blocking element may comprise an activation surface and the at least one unblocking element may comprise a cam for pushing the activation surface in a radial direction when a contact between the cam and the activation surface is established.

The blocking element in the form of a spring member may favorably realize the blocked mode where a lip is in protruded position and blocks an access to the sealing area of the safety assembly of the filter system. By pushing the activation surface in a radially inward direction the lip may be pushed back too, thus switching to the unblocked mode where access of the sealing structure of the filter element to the sealing area may be granted.

According to a favorable embodiment of the filter element, the unblocking element may comprise at least one cam arranged at the center pipe pointing radially inwards. Thus, by moving the filter element in the longitudinal direction the cam at the center pipe of the filter element gets into contact with the activation surface of the blocking member which is positioned inside the housing cover. The cam pushes the activation surface radially inwards and unblocks the access to the sealing area of the safety assembly.

According to a favorable embodiment, the filter element may comprise a coding element configured to cooperate with a coding counter element arranged in the safety assembly, when the filter element is mounted to a housing of the filter system. Thus, a fixed assignment of a filter element to a defined filter system is possible. The filter system is preventing the use of a filter element without such a coding element or the wrong coding element, because access to the sealing area of the safety assembly may be blocked by the blocking element.

According to a favorable embodiment of the filter element, the coding element may be formed as a protruding pin arranged at the center pipe pointing radially inward. Advantageously the filter element may be mounted to the housing cover by inserting the pin into an appropriate groove of the blocking element simultaneously with inserting the cam as unblocking element into a guiding groove. Thus, the use of a filter element without such a coding element or the wrong coding element may be prevented, because access to the sealing area of the safety assembly may be blocked by the blocking element.

According to a favorable embodiment of the filter element, the blocking element may comprise at least one spring member comprising the activation surface and a radially protruding lip, wherein the lip is retractable from its blocking position by pushing the activation surface in a radial direction. The spring member may favorably realize the blocked mode where the lip is in protruded position and blocks an access to the sealing area of the safety assembly. By pushing the activation surface in a radially inward direction the lip may be pushed back too, thus switching to the unblocked mode where access of the sealing structure of the filter element to the sealing area may be granted.

### BRIEF DESCRIPTION OF THE DRAWINGS

The present invention together with the above-mentioned and other objects and advantages may best be understood from the following detailed description of the embodiments, but not restricted to the embodiments, wherein is shown in:

FIG. 1 a cut view through a filter system with a safety assembly and a filter element according to an embodiment of the invention;

FIG. 2 a cut view through the filter element of the filter system of FIG. 1 connected to the blocking element;

FIG. 3 a cut perspective view of the filter element of FIG. 1;

FIG. 4 a bottom side view on an end cap of the filter element of FIG. 1;

FIG. 5 a perspective view of a first section of the safety assembly of FIG. 1;

FIG. 6 another perspective view of a first section of the safety assembly of FIG. 1;

FIG. 7 a cut perspective view of the first section of the safety assembly of FIG. 1;

FIG. 8 a perspective view of a spring member of the safety assembly of FIG. 7;

FIGS. 9 to 13 successive steps of an interaction of the sections of the safety assembly during mounting of the filter element in cut perspective views of the filter element and the safety assembly; and

FIGS. 14 to 17 successive steps of an interaction of the sections of the safety assembly during mounting of the filter element in cut views of the filter element and the safety assembly.

### DETAILED DESCRIPTION OF THE DRAWINGS

In the drawings, like elements are referred to with equal reference numerals. The drawings are merely schematic representations, not intended to portray specific parameters of the invention. Moreover, the drawings are intended to depict only typical embodiments of the invention and therefore should not be considered as limiting the scope of the invention.

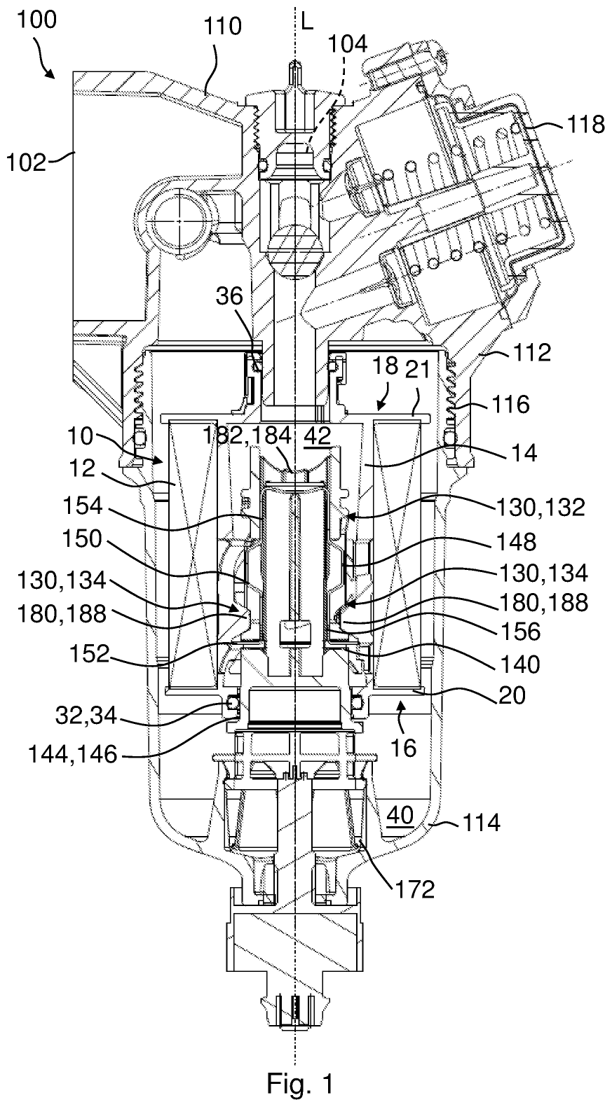

FIG. 1 depicts a cut view through a filter system 100 with a safety assembly 130 and a filter element 10 according to an embodiment of the invention.

The filter system 100 comprises a housing 110 with a housing head 112 and a housing cover 114, a fluid inlet 102 and a fluid outlet 104 and a filter element 10 being accommodated in the housing 110. The filter system 100 may be used for filtering fluids, particularly for motor oil. The filter element 10 is mounted to the housing cover 114 and then the housing cover 114 with the filter element 10 is mounted to the housing head 112 by inserting it into the housing head 112. The housing 110 is closed by tightening the screw connection 116. A fluid inlet 102 is arranged in the housing head 112 as well as a fluid outlet 114, which is not visible in the Figure. Also, a hand pump 118 is arranged in the filter head 112 for conveying fuel after maintenance action.

The filter element 10 separates a raw fluid region 40 inside the housing 110 from a filtered fluid region 42 by being sealed on the first end cap with the gasket 34 against the sealing surface 146 of the sealing area 144 of the blocking element 140 and on the other end cap 21 with the gasket 36 against the fluid outlet 104 in the housing head 112.

Fluid to be filtered enters the housing 110 of the filter system 100 through the fluid inlet 102, passes the filter bellows 12 from the raw fluid region 40 on the outside of the filter element 10 to the filtered fluid region 42 on the inside of the filter element 10. The filtered fluid exits the housing 110 through the fluid outlet 104. Fluid inlet 102 and fluid outlet 104 are both arranged in the housing head 112.

For changing the filter element 10 due to maintenance action the housing cover 114 is unscrewed and dismounted from the housing head 112 together with the filter element 10.

The filter element 10 comprises a center pipe 14 having a longitudinal direction L and being surrounded by a filter bellows 12.

The filter bellows 12 comprises an end cap 20, 21 at one or both of its end regions 16, 18. The filter element 10 further comprises a sealing structure 32 with a gasket 34 at the end cap 20 for sealing against a safety assembly 130, whereas a second gasket 36 is provided at the other end cap 21 for sealing against the fluid outlet 104 of the housing head 112.

The safety assembly 130 is arranged inside the housing 110 and exhibits a blocking mode and an unblocking mode depending on an axial and/or rotational position of the filter element 10 in the housing 110. The safety assembly 130 is configured to provide access of the sealing structure 32 of the filter element 10 to the sealing area 144 of the safety assembly 130 in the unblocking mode and to block access of the sealing structure 32 of the filter element 10 to the sealing area 144 in the blocking mode when the sealing structure 32 of the filter element 10 is moved towards the sealing area 144.

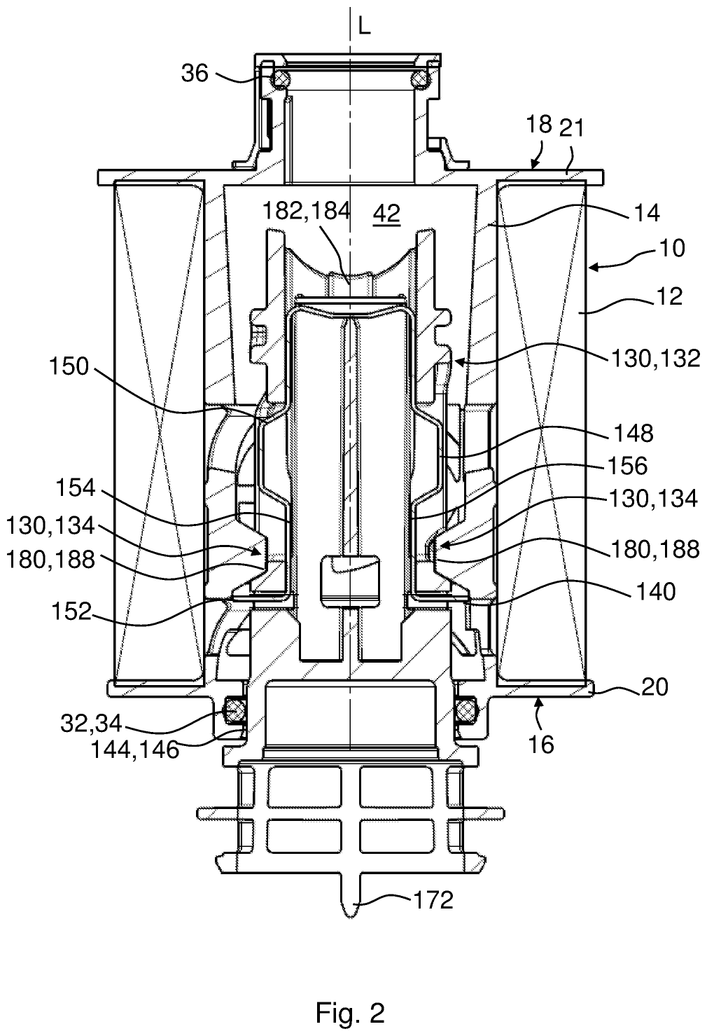

FIG. 2 depicts a cut view through the filter element 10 of the filter system 100 connected to the blocking element 140 as the first section 132 of the safety assembly 130.

The safety assembly 130 has a blocking mode and an unblocking mode depending on an axial and/or rotational position of the filter element 10 in the housing 110. The safety assembly 130 is configured to provide access of the sealing structure 32 of the filter element 10 to the sealing area 144 of the blocking element 140 of the safety assembly 130 in the unblocking mode and to block access of the sealing structure 32 of the filter element 10 to the sealing area 144 in the blocking mode when the sealing structure 32 of the filter element 100 is moved towards the sealing area 144.

The safety assembly 130 has a first section 132 arranged at the housing 110 and a second section 134 arranged at the filter element 10. The first section 132 comprises a blocking element 140. The second section 134 comprises an unblocking element 180 configured to cooperate with the blocking element 140. The blocking element 140 comprises an activation surface 148. The unblocking element 180 comprises a cam 188 for pushing the activation surface 148 in a radial direction when a contact between the cam 188 and the activation surface 148 is established.

The blocking element 140 comprises a single spring member 150 with two spring member branches 154, 156 comprising the activation surfaces 148 and radially protruding lips 152, wherein the lip 152 is retractable from its blocking position by pushing the activation surface 148 in a radial direction. The blocking element 140 is fixed to the housing cover 114 by mounting members 172 which are extended in the longitudinal direction L and arranged in a circumference at a radial distance from the axis L.

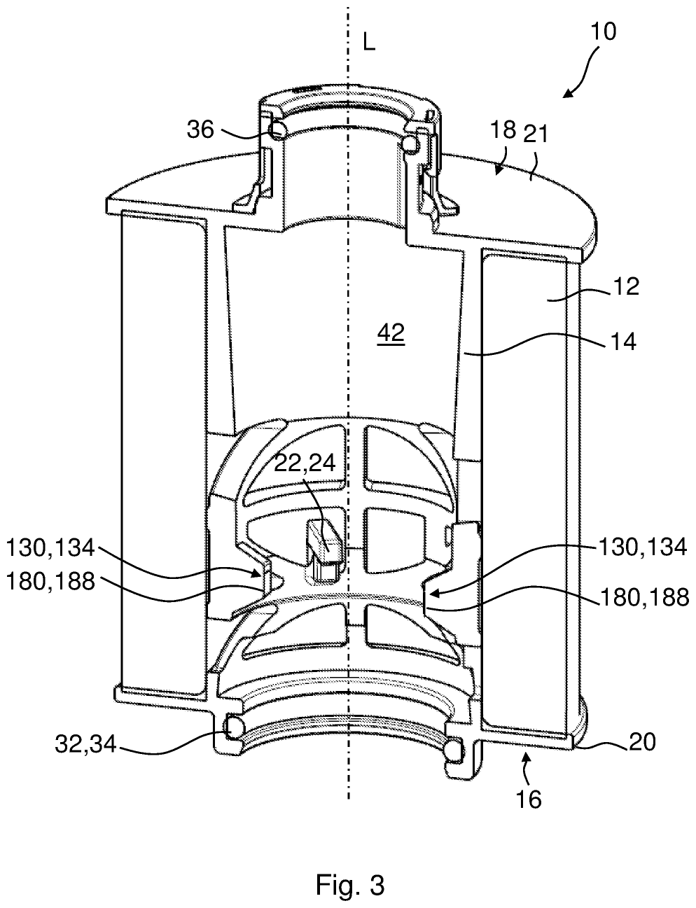

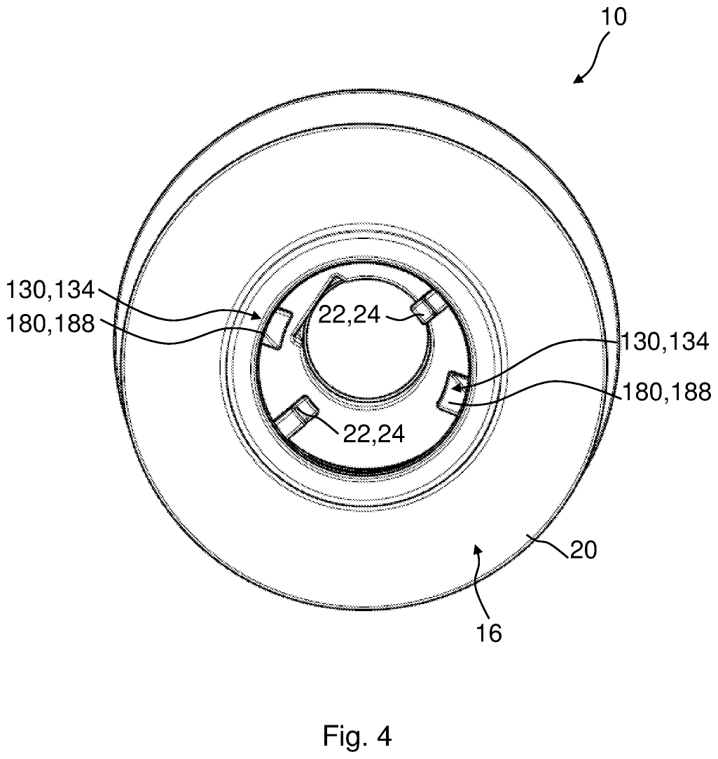

FIG. 3 depicts a cut perspective view of the filter element 10, whereas FIG. 4 depicts a bottom side view on an end cap 20 of the filter element 10.

The filter element 10 comprises two coding elements 22 configured to cooperate with corresponding coding counter elements 182 arranged in the safety assembly 130, when the filter element 10 is mounted to the housing 110. The coding elements 22 are formed as protruding pins 24 arranged at the center pipe 14 of the filter element 10 pointing radially inward.

In FIG. 3 the center pipe 14 is to be seen, supporting radially inward protruding cams 188 as unblocking elements 180, as well as also radially inward protruding pins 24 as coding elements 22. Two cams 188 and two pins 24 are arranged on an inner circumference of the center pipe 14 as is particularly to be seen in FIG. 4 from a bottom side of the filter element 10. The two cams 188 and the two pins 24 are positioned pairwise opposite to each other.

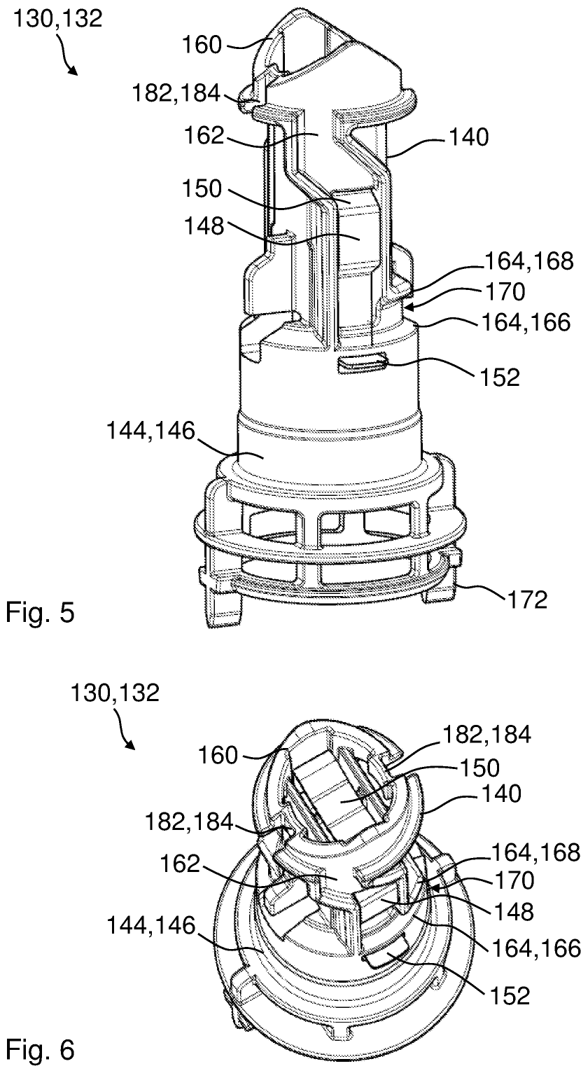

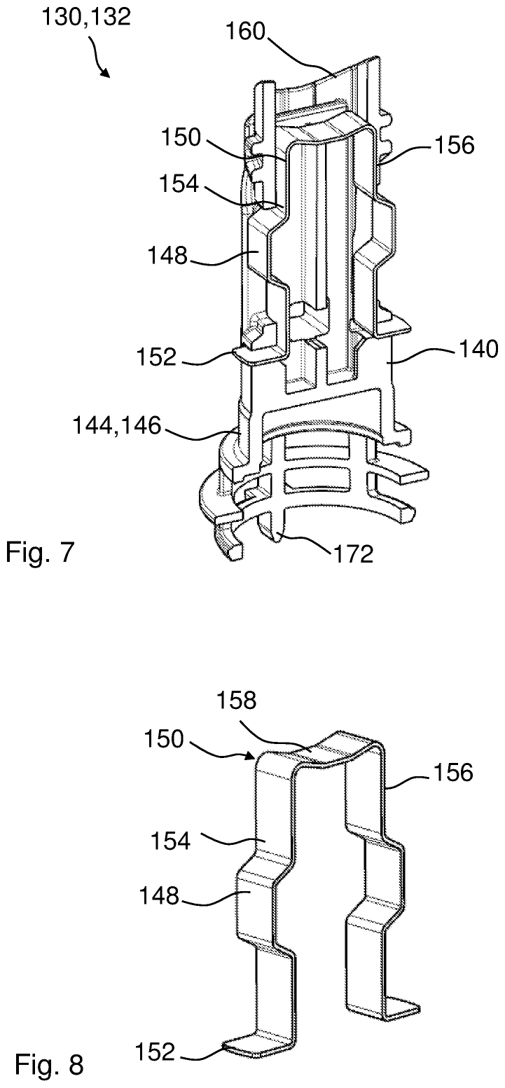

FIGS. 5 and 6 depict perspective views of a first section 132 of the safety assembly 130. FIG. 7 depicts a cut perspective view of the first section 132 of the safety assembly 130, whereas in FIG. 8 a perspective view of a spring member 150 of the safety assembly 130 is shown.

The blocking element 140 as part of the first section 132 of the safety assembly 130 comprises the single spring member 150. The single spring member 150 is arranged in the blocking element 140 parallel to the longitudinal direction L, and is formed U-shaped comprising two spring member branches 154, 156 parallel to the longitudinal direction L.

The spring member branches 154, 156 comprise the activation surfaces 148 and the lips 152 radially protruding in the blocking mode of the safety assembly 130, thus preventing access of the sealing structure 32 of the end cap 20 to the sealing area 144 of the blocking element 140. The lip 152 is at least partly radially inward retractable from its blocking position by pushing the activation surface 148 in a radial direction.

The blocking element 140 is realized as a cage and comprises a guiding groove 162 which leads the cam 188 as the unblocking element 180 to the activation surface 148 by a rotational movement when moving the filter element 10 in the longitudinal direction L towards the blocking element 140.

The blocking element 140 further comprises a locking structure 164 wherein the filter element 10 is locked to the blocking element 140 when the cam 188 is inserted into the locking structure 164 by a rotational movement of the filter element 10 after surpassing the activation surface 148 by the cam 188 in the longitudinal direction L. For this purpose, the locking structure 164 comprises two neighbored ribs 166, 168 arranged on a circumference of the blocking element 140. The filter element 10 is locked to the blocking element 140 by the lip 152 of the spring member 150 when the cam 188 is moved to an end position 170 by a rotational movement of the filter element 10 after surpassing the activation surface 148 by the cam 188 in the longitudinal direction L.

In the unblocking mode access of the sealing structure 32 of the filter element 10 to the sealing area 144 of the blocking element 140 is provided when the lips 152 of the two spring members 150 of the blocking element 140 are retracted radially inward. When the cams 188 are moved to an end position 170 by a rotational movement of the filter element 10 and push the activation surfaces 148 radially inward by a rotational and translational movement in the longitudinal direction L the lips 152 are retracted and access is provided.

Also, to be seen in FIGS. 5 and 6 is the coding counter element 182 which is formed as a groove 184 in the blocking element 140 parallel to the longitudinal direction L. The blocking element 140 comprises a positioning structure 160 connected to the groove 184 which leads the pin 24 arranged at the center pipe 14 of the filter element 10 (see FIGS. 3 and 4) to the groove 184 by a rotational movement when moving the filter element 10 in the longitudinal direction L towards the blocking element 140.

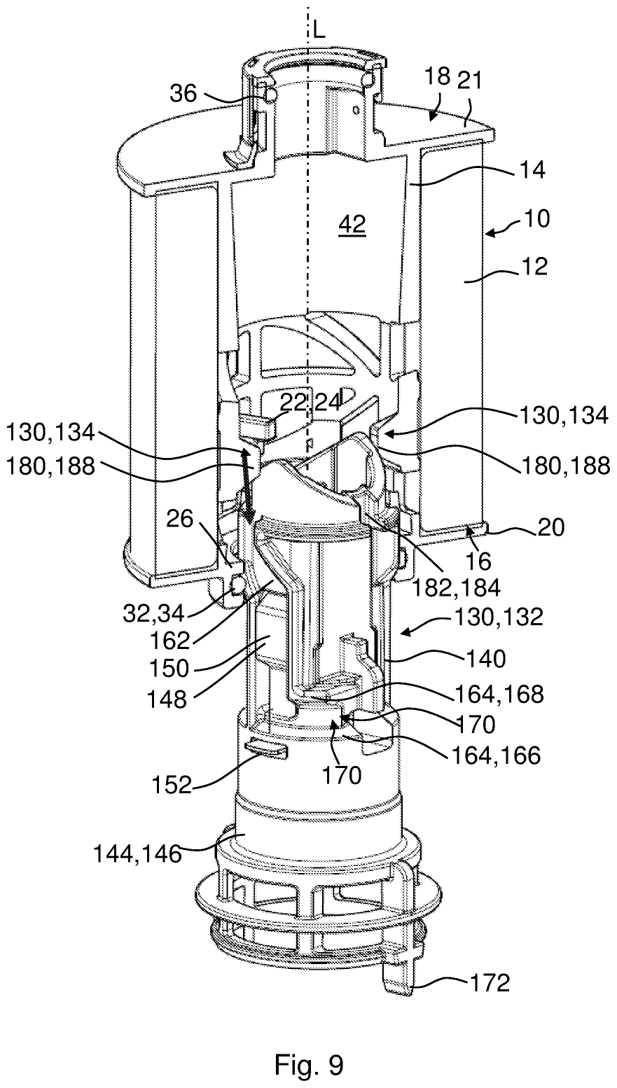

In FIGS. 9 to 13 successive steps of an interaction of the sections 132, 134 of the safety assembly 130 during mounting of the filter element 10 are depicted in cut perspective views of the filter element 10 and the safety assembly 130. The housing 110 of the filter system 100 is represented by the blocking element 140 of the safety assembly 130.

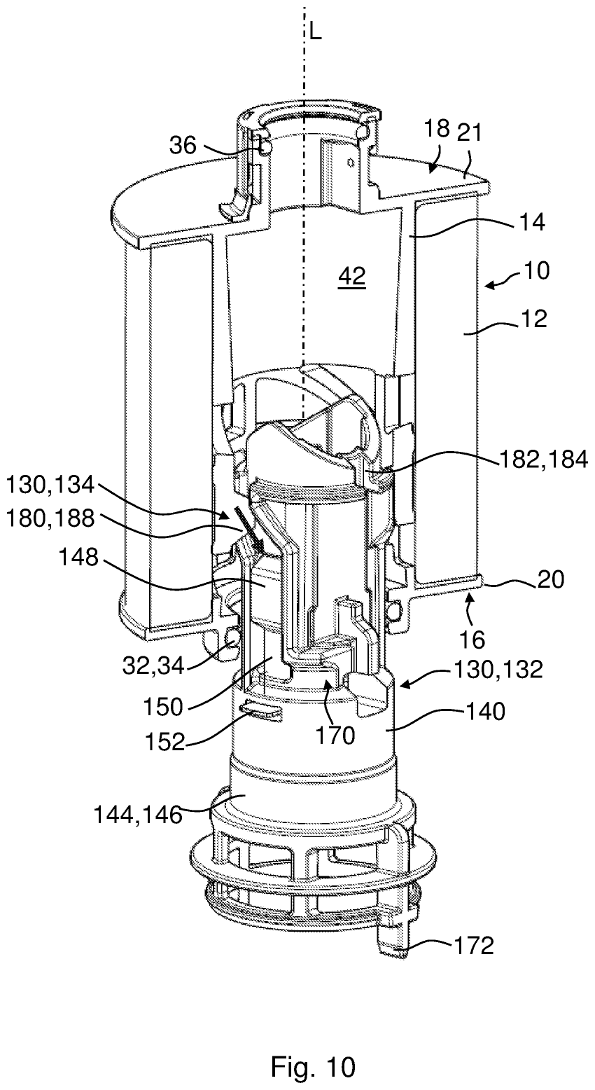

By moving the filter element 10 in the longitudinal direction L to the blocking element 140 thus performing a rotational movement of the end cap 20 together with the filter element 10 the cams 188 are guided in the guiding grooves 162 to the activation surfaces 148 of the spring members 150, as shown in FIGS. 9 and 10, indicated by arrows.

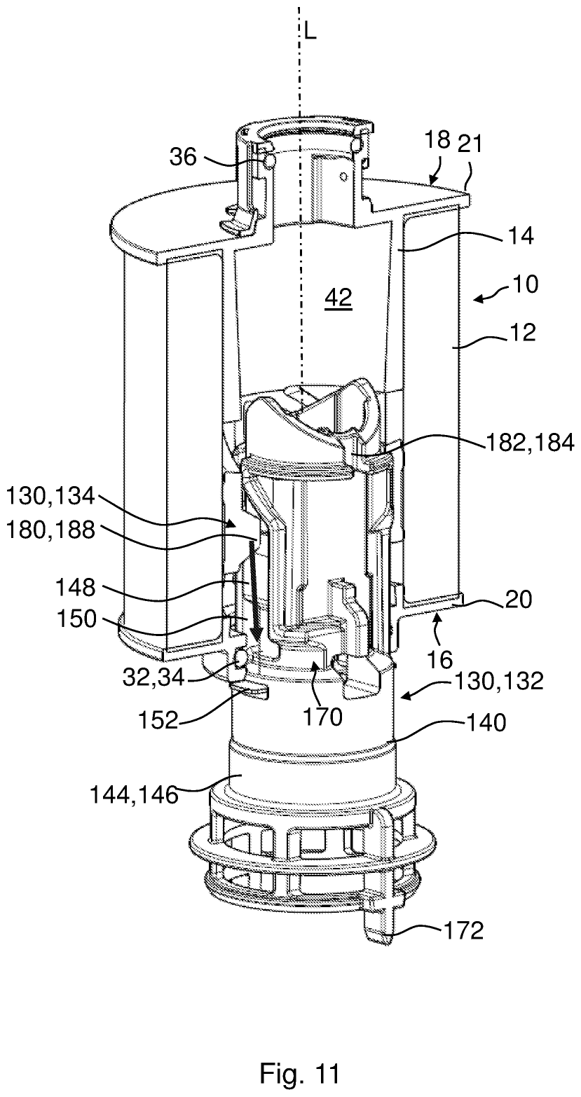

In FIG. 11 the blocking element 140 is still shown in the blocking mode where the lips 152 of the spring member 150 are protruding radially outward from the circumference of the blocking element 140. The sealing structure 32 of the filter element 10 is still above the protruding lips 152 preventing access to the sealing area 144. The cams 188 start to push the activation surfaces 148 radially inward thus moving the lips 152 radially inward and providing access to the sealing area 144.

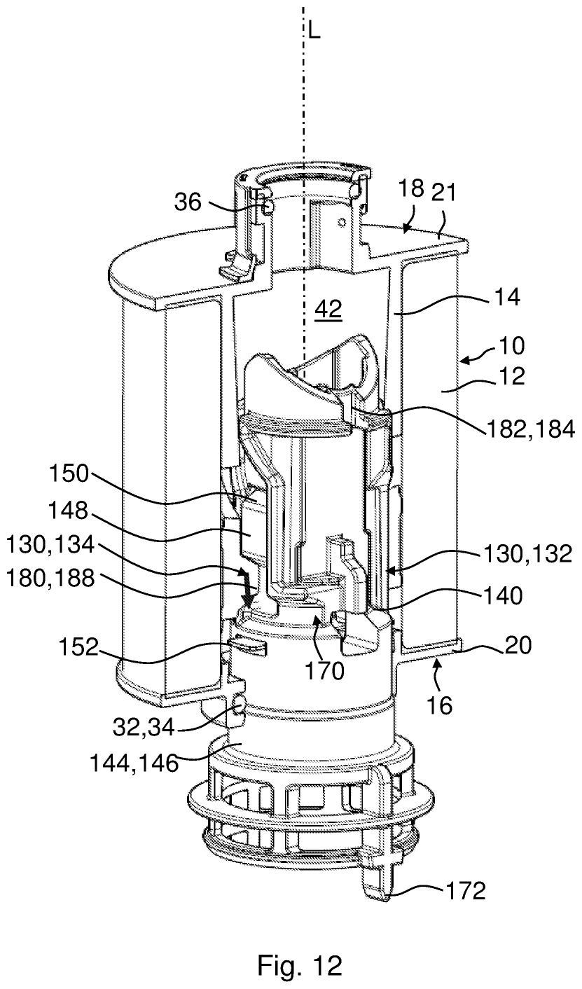

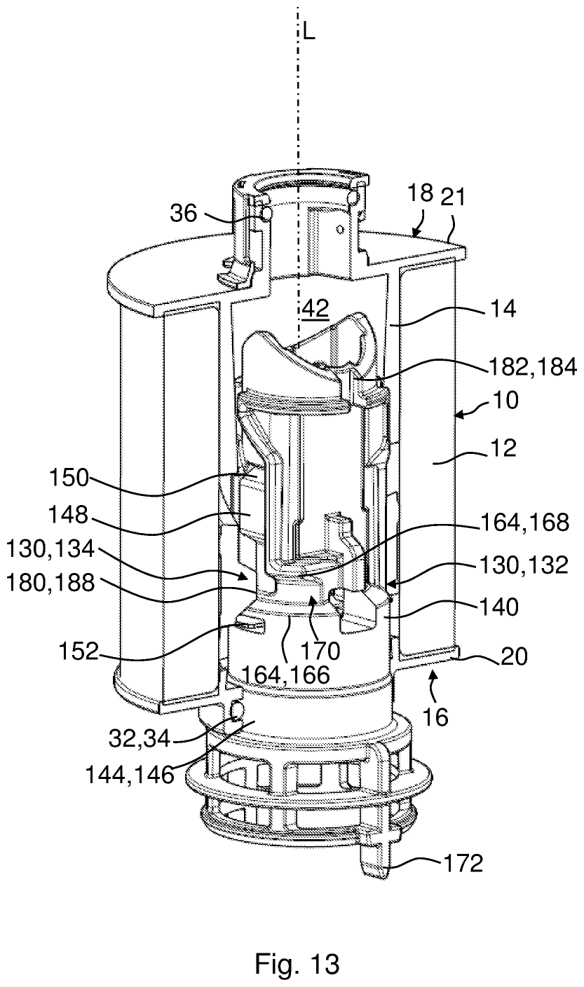

In FIG. 12 the sealing structure 32 has surpassed the lips 152 and are moved towards the sealing area 144 which is reached in FIG. 13. The cams 188 have also surpassed the activation surfaces 148 and the lips 152 are protruding again.

In FIG. 13 the cams 188 are at their lowest positions and are ready to be moved by further rotating the filter element 10 to their end positions 170 where the filter element 10 is locked by the locking structure 164.

During lowering down the filter element 10 along the longitudinal direction L depicted in the FIGS. 9 to 13 the pin 24 as the coding element 22 is led into the groove 184 as the coding counter element 182. Thus, the filter element 10 with such a coding element 22 may only be mounted to a housing 110 of a filter system 100 with such a coding counter element 182 at the blocking element 140.

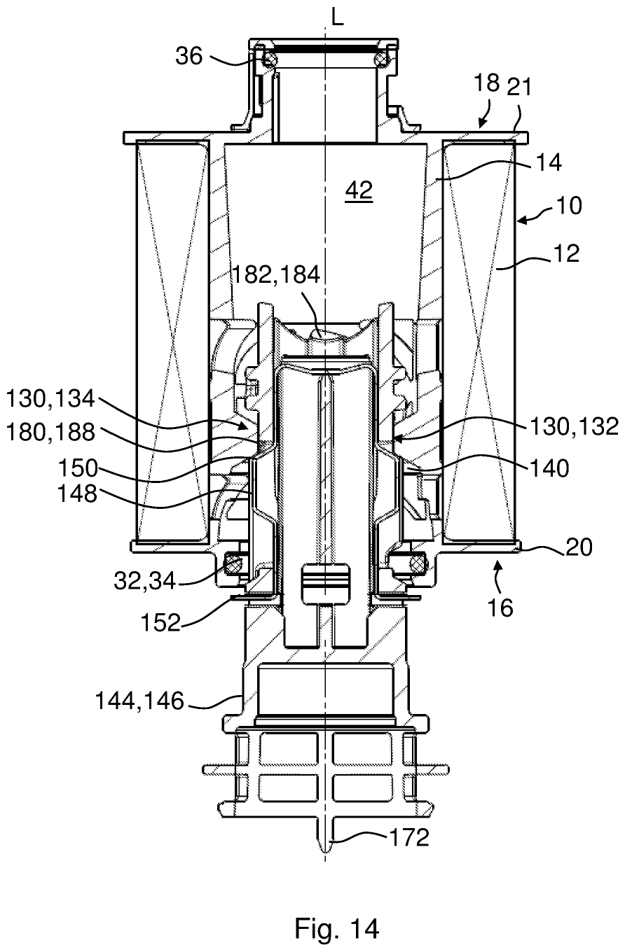

In FIGS. 14 to 17 successive steps of the interaction of the sections 132, 134 of the safety assembly 130 during mounting of the filter element 10 is depicted in cut views of the filter element 10 and the safety assembly 130.

In FIG. 14 the cams 188 are just at the beginning of pushing the activation surfaces 148 radially inward when the filter element 10 is further moved down along the longitudinal direction L. The lips 152 of the spring member 150 are still protruding and preventing access of the sealing structure 32 of the end cap 20 of the filter element 10 to the sealing area 144 of the blocking element 140.

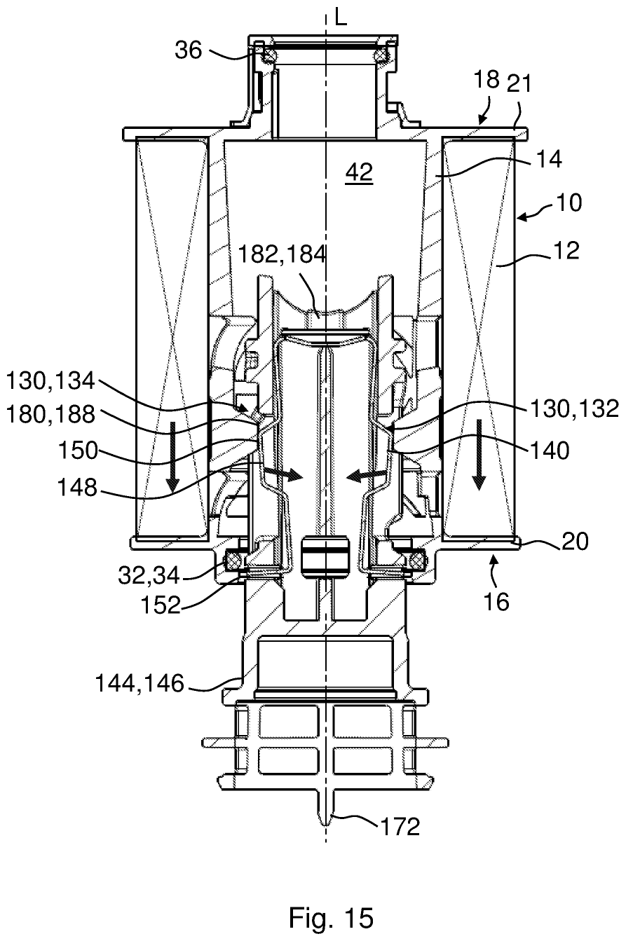

In FIG. 15 the activation surfaces 148 of the spring member 150 are pushed by the cams 188 radially inward thus moving the lips 152 also radially inward. In this position access of the sealing structure 32 to the sealing area 144 is provided when the filter element 10 is further moved down along the longitudinal direction L. Movements of the filter element 10 and the activation surfaces 148 are indicated by arrows.

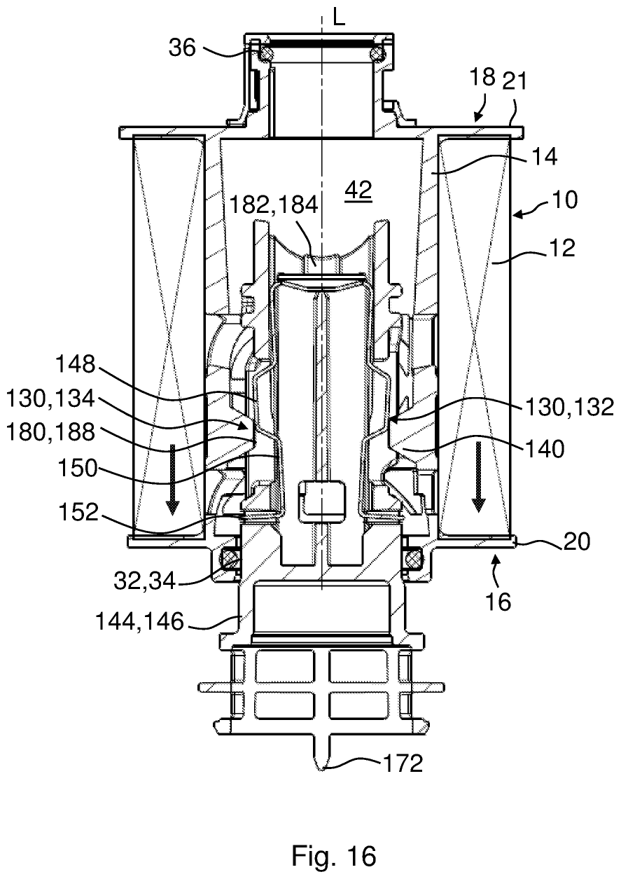

Then the filter element 10 may be moved down along the longitudinal direction L approaching the sealing area 144 by the sealing structure 32 of the end cap 20 which is shown in FIG. 16.

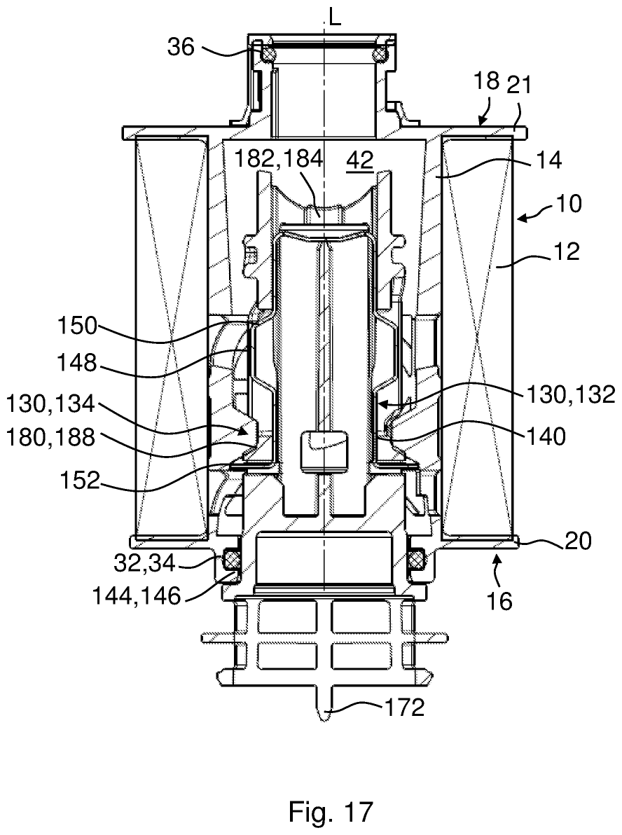

In FIG. 17 the filter element 10 is depicted in its end position with the sealing structure 32 at the sealing area 144 thus sealing the raw fluid region 40 against the filtered fluid region 42. The lips 152 are protruding again because the activation surfaces are no longer pushed radially inward. The cams 188 are at their end positions 170.

### REFERENCE NUMERALS

10 filter element
12 filter bellows
14 center pipe
16 end region
18 end region
20 end cap
21 end cap
22 coding element
24 pin
32 sealing structure
34 gasket
36 gasket
40 raw fluid region
42 filtered fluid region
100 filter system
102 fluid inlet
104 fluid outlet
110 housing
112 housing head
114 housing cover
116 screw connection
118 hand pump
130 safety assembly
132 first section
134 second section
140 blocking element
144 sealing area
146 sealing surface
148 activation surface
150 spring member
152 lip
154 spring member branch
156 spring member branch
158 bridge member
160 positioning structure
162 guiding groove
164 locking structure
166 rib
168 rib
170 end position
172 mounting member
180 unblocking element
182 coding counter element
184 groove
188 cam
L longitudinal direction

1. A filter system comprising a housing with a housing head and a housing cover, a fluid inlet and a fluid outlet and a filter element being accommodated in the housing,
the filter element comprising a center pipe having a longitudinal direction and being surrounded by a filter bellows, the filter bellows comprising an end cap at one or both of its end regions, the filter element further comprising a sealing structure, particularly a gasket, at the end cap,
wherein a safety assembly is arranged inside the housing, having a blocking mode and an unblocking mode depending on an axial and/or rotational position of the filter element in the housing and being configured to provide access of the sealing structure of the filter element to a sealing area of the safety assembly in the unblocking mode and to block access of the sealing structure of the filter element to the sealing area of the safety assembly in the blocking mode when the sealing structure of the filter element is moved towards the sealing area,
the safety assembly having a first section arranged at the housing and a second section arranged at the filter element, the first and second sections comprising at least one blocking element and at least one unblocking element configured to cooperate with the at least one blocking element,
the at least one blocking element comprising an activation surface and the at least one unblocking element comprising a cam for pushing the activation surface in a radial direction when a contact between the cam and the activation surface is established.

2. The filter system according to claim 1, wherein the blocking element comprises at least one spring member comprising the activation surface and a radially protruding lip, wherein the lip is retractable from its blocking position by pushing the activation surface in a radial direction.

3. The filter system according to claim 1, wherein the blocking element comprises a guiding groove which leads the unblocking element to the activation surface by a rotational movement when moving the filter element in the longitudinal direction towards the blocking element.

4. The filter system according to claim 1, wherein the blocking element comprises a locking structure wherein the filter element is locked to the blocking element when the cam is inserted into the locking structure by a rotational movement of the filter element after surpassing the activation surface by the cam in the longitudinal direction.

5. The filter system according to claim 4, wherein the locking structure comprises two neighbored ribs arranged on a circumference of the blocking element.

6. The filter system according to claim 2, wherein the filter element is locked to the blocking element by the lip of the spring member when the cam is moved to an end position by a rotational movement of the filter element after surpassing the activation surface by the cam in the longitudinal direction.

7. The filter system according to claim 2, wherein a single spring member is arranged in the blocking element parallel to the longitudinal direction, which is formed U-shaped comprising two spring member branches parallel to the longitudinal direction, wherein the spring member branches are connected by a bridge member.

8. The filter system according to claim 1, wherein the filter element comprises at least one coding element configured to cooperate with a coding counter element arranged in the safety assembly, when the filter element is mounted to the housing.

9. The filter system according to claim 8, wherein the coding element is formed as a protruding pin arranged at the center pipe of the filter element pointing radially inward, whereas the coding counter element is formed as a groove in the blocking element parallel to the longitudinal direction,
in particular, wherein the blocking element comprises a positioning structure connected to the groove which leads the pin to the groove by a rotational movement when moving the filter element in the longitudinal direction towards the blocking element.

10. A safety assembly for a filter system according to claim 1, the filter system comprising a filter element and a housing,
having a sealing area and having a blocking mode and an unblocking mode depending on an axial and/or rotational position of the filter element in the housing and
being configured to provide access of a sealing structure of the filter element to a sealing area of the safety assembly in the unblocking mode and to block access of the sealing structure of the filter element to the sealing area in the blocking mode when the sealing structure of the filter element is moved towards the sealing area, having a first section arranged at the housing and a second section arranged at the filter element, the first and second sections comprising at least one blocking element and at least one unblocking element configured to cooperate with the at least one blocking element,
the at least one blocking element comprising an activation surface and the at least one unblocking element comprising a cam for pushing the activation surface in a radial direction when a contact between the cam and the activation surface is established.

11. A filter element for a filter system according to claim 1, comprising a center pipe having a longitudinal direction and being surrounded by a filter bellows, the filter bellows comprising an end cap at one or both of its end regions, and comprising a section of a safety assembly with either at least one unblocking element or at least one blocking element configured to cooperate with either the at least one blocking element or the at least one unblocking element of a first section of the safety assembly, the filter element further comprising a sealing structure, particularly a gasket, on one of its end regions,
wherein the at least one blocking element and the at least one unblocking element are configured to provide access of the sealing structure to a sealing area of the safety assembly in the unblocking mode and to block access of the sealing structure to the sealing area in the blocking mode when the sealing structure of the filter element is moved towards the sealing area.

12. The filter element according to claim 11, wherein the at least one blocking element comprises an activation surface and the at least one unblocking element comprises a cam for pushing the activation surface in a radial direction when a contact between the cam and the activation surface is established.

13. The filter element according to claim 11, wherein the unblocking element comprises at least one cam arranged at the center pipe pointing radially inwards.

14. The filter element according to claim 11, comprising a coding element configured to cooperate with a coding counter element arranged in the safety assembly, when the filter element is mounted to a housing of the filter system.

15. The filter element according to claim 14, wherein the coding element is formed as a protruding pin arranged at the center pipe pointing radially inward.

16. The filter element according to claim 11, wherein the blocking element comprises a spring member comprising the activation surface and a radially protruding lip, wherein the lip is retractable from its blocking position by pushing the activation surface in a radial direction.
